(19) United States
(12) Patent Application Publication
(10) Pub. No.: US 2019/0279194 A1
(43) Pub. Date: Sep. 12, 2019

(54) METHOD TO AUTOMATICALLY ENABLE AND DISABLE AN ELECTRONIC PAYMENT INSTRUMENT THROUGH THE PROCESSING OF THE GEOGRAPHICAL POSITION OF THE ASSOCIATED USER

(71) Applicant: Opentech Payment Services AG, Zug (CH)

(72) Inventors: Stefano ANDREANI, Zug (CH); Valerio Ferratelli, Zug (CH)

(21) Appl. No.: 16/294,124

(22) Filed: Mar. 6, 2019

(30) Foreign Application Priority Data
Mar. 6, 2018 (EP) 18425011.6

(51) Int. Cl. G06Q 20/32; H04W 4/029; G06Q 20/40

(52) U.S. Cl. CPC G06Q 20/3224; G06Q 20/405; H04W 4/029

(57) ABSTRACT

The present disclosure can include a method aimed at reducing the number of payment instrument frauds, when it is possible to enable a control configuration based on the associated user's geographical position. The method can act through an automated mechanism designed to adapt to the user's mobility needs, automatically modifying the area enabled for payments. The setup of the configuration can take place automatically and without needing the user's input, by monitoring the user's location through a device associated with the user.

The method described can have the ability to adapt to non-optimal conditions in terms of precision of the acquired geographical coordinates and/or temporary lack of network connection with remote systems, automatically converging towards a solution that maximizes the effectiveness of the method.

### CROSS REFERENCE TO RELATED APPLICATIONS

This application claims priority to European Application No. 18425011.6, filed on Mar. 6, 2018, the entire disclosure of which is hereby incorporated by reference.

### FIELD

The present disclosure relates to the automation of the configuration of electronic payment instruments in order to reduce the occurrence of frauds compared to a manual configuration.

### BACKGROUND

Today there are many types of electronic payment instruments, the most known ones are credit and debit cards.

Payment instruments can be used to purchase goods and services at physical stores, to make online purchases, and to withdraw cash at ATM's. The increase of payment instruments and the expansion of the acceptance network make it necessary to introduce measures to limit possible fraud.

A possible countermeasure is the possibility for the legitimate user of a payment instrument to configure such an instrument by limiting some specific uses. Typical examples of block types are:
Online purchases and the possibility of specifying a sub-set of categories (eg: gambling sites)
Purchases at physical stores
ATM withdrawals

A recent configuration possibility is the blocking of transactions based on the geographical location of the user and/or the merchant.

In this configuration, the user's geographical position is associated with the geographical location of a device associated with the user. This device is able to acquire and process its geographical position. The geographical position of a merchant (in case of a physical store) is acquired using the location of the payment terminal.

Localization technology is typically used in two forms:

I) In a form, available in solutions commonly used in the financial environment, such as MasterCard's InControl, the user, through a configuration service, pre-selects a set of geographical areas in which enables payments. In this way, geographical areas are implicitly specified where payments are disabled. Normally these geographical areas coincide with the geopolitical boundaries of all the Countries. When the transaction is made by using the pre-configured payment instrument, the geographic position of the merchant is compared to the enabled geographical areas; if a match is not found, the transaction is rejected.

The limit of this solution is constituted by the static nature of the set of areas enabled for payments. This set is typically configured so that it is reduced to the geographical areas in which the user typically operates, such as the country of residence. On the other hand, electronic payment instruments are typically used when a user travels for work or for leisure.

In this case the user must:
before departure: remember to enable the geographical area of destination;
return: remember to rehabilitate the geographical area of residence.

If the user forgets to change the configuration, the user will only be aware of the error during the first use of the payment instrument and, in the worst case, he may even not remember having set a block based on the geographical position. In these cases, after experiencing an uncomfortable situation, the user is forced to contact the payment instrument supplier to solve the issue.

II) Another form, described for example in EP2287792, consists in requesting at the moment of the transaction the user's position by an associated device. If the device is not within a reasonable range of the merchant's position, the transaction is rejected.

The limitation of this solution is the need to acquire the user's geographical position in a specific moment and to be able to communicate it to the payment instrument management service in a reasonable time. In the worst case, the user's location may not be available (such as inside buildings), or the device may not be able to transmit, such as when the user is abroad and does not have an active roaming data traffic.

Another limitation of this solution is that in order to work correctly, it requires to have both the user's and the merchant's location available at the same time.

Another limitation of this solution is that, in order to work, it requires a periodic or continue acquisition of the position, and high precision coordinates.

III) Another form, described for example in US2016321643A10, consists in using the user geographical position in order to enable payment methods already declared as compromised or unusable, on a restricted basis.

The limitation of this method is that it acts only when the fraud has already happened.

In this context the solution according to some embodiments of the present disclosure is inserted, which proposes to implement an approach based on the automatic management of the areas authorized for payments, through which it is sufficient to obtain, at the moment of payment, the merchant's position and compare it with the area currently authorized for payments for that instrument.

### SUMMARY

The object of some embodiments of the present disclosure is to reduce the number of frauds for payment instruments that allow a control configuration based on the geographical position.

The method works through an automated mechanism designed to automatically adapts to the user's mobility needs, being able to use a high variety of coordinate acquisition methods and different levels of coordinate precision, without interfering with the results.

The mechanism works by automatically modifying a payment-enabled area for a payment instrument. The setup on the configuration of the areas takes place automatically and without needing the user's input, by monitoring the user's geographical position through a device associated with the user.

The described method has the ability to automatically converge on a solution, maximizing the reliability of the automatic setup by tuning the precision required during the acquisition of the geographical coordinates. The system prefers a low consumption and minimum precision mode, but it is able to temporarily scale to a high precision mode when this is necessary to achieve optimal effectiveness.

The method identifies a “solution” when it is able to change the configuration of the payment method, consistently with the user's position, modifying the procedure used to reach said solution in case the device operates under sub-optimal conditions. In particular, the present method is able to produce a solution even if the communication channel is temporarily interrupted or the geographic coordinate acquisition module provides coordinates with low precision.

### BRIEF DESCRIPTION OF THE DRAWINGS

Some aspects of the features and advantages offered by the present disclosure will be clarified by taking advantage of the figures listed here, the detailed description and the claims.

FIG. 1: shows a high-level diagram of the components involved in an embodiment of the method described in the present disclosure.

FIG. 2: shows a simplified block diagram of an embodiment of the method described in the present disclosure.

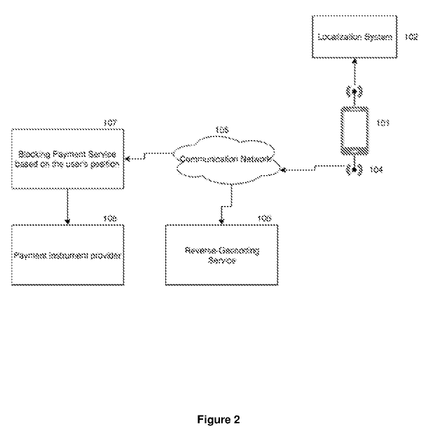

### DETAILED DESCRIPTION

In the present description, the reference to the term “in an embodiment” means that a specifically described structure, feature or functionality may be included in at least one form.

The use of the term at various points in the description is not necessarily related to the same embodiment, nor that several embodiments are necessarily alternative or mutually exclusive compared to other embodiments.

It is therefore a specific object of some embodiments of the present disclosure to provide a method to automatically enable or disable an authorized area in an electronic payment instrument configuration by processing the geographical position of a user associated with the instrument, which comprises:
1. a preliminary and a one-time step in which a device that can detect geographical coordinate data is associated to a payment instrument and to a user who represents the legitimate user of the instrument;
   and, subsequently, periodically, the following phases:
2. acquiring the position of the aforementioned user, by means of said device, associated to the user;
3. checking if the acquired position is included in an area previously authorized to make payments;
   if the acquired position is not included within said area previously authorized to make payments,
4. the system automatically sending to a remote payment instrument management system a command to change the configuration of the payment instrument;
5. the command to change the configuration of the payment instrument, run by said remote system, enabling the area associated with the acquired position and at the same time disabling the previously authorized area.

In the above said method, the acquisition of the user's position is not limited to the continuous receiving of geographical coordinates, but also includes:
the use of means capable of providing geographical coordinates at regular or irregular time intervals;
the use of means capable of providing geographical coordinates of the places visited by the user, ignoring the coordinates characterizing the relevant movements that lead him to such places. This kind of means are part of the technology used to acquire the geographic coordinate and is not part of some embodiments of the present disclosure. For example, a means can detect the event “the user was moving and now he is still” by using an accelerometer and notify the event that “the user has arrived in a place”.

The method comprises:
the ability to use the information provided by the geographic coordinate acquisition module even when it is in the condition of having to provide the coordinates with an accuracy equal to or near its lower limit, in this case the system automatically acting by composing the available areas in super-sets characterized by an extension greater than or equal to said value;
the ability to automatically scale from a geographical coordinates low-precision profile to a high-precision profile to maximize the precision of said checking phase that determines if the position where the user is located is included in the area previously authorized to make payments;
the ability to determine the user's logical position (reverse-geocoding) through the use of preloaded information available on the device, as well as by using remote services.

In the method described here the command to change the configuration of the payment instrument is communicated to a remote system that deals with the management of the payment instrument.

The method includes the ability to automatically converge on a solution even in the case of temporary lacking one of the following requirements for its completion:
a geographical coordinate of the device as provided by a Localization system [102]
a communication channel [105]

In this case the method by activating a mode that can detect a change in the aforementioned requirements in order to complete the procedure as soon as possible and, in addition, can send a proactive notification to the user, which informs of the lack of said requirements.

In the method described here, the user's geographical position is obtained using any technology capable of acquiring geographical coordinates, such as for example:
a GPS receiver associated to the device;
A-GPS position detection technologies.

The command to change the configuration of the payment instrument and all the information necessary for the correct execution of the command are communicated in encrypted form and are decrypted by the payment instrument management system.

The command to change the configuration of the payment instrument, and all the necessary information for its execution, are cryptographically signed to guarantee the sender authentication and the non-repudiation of the command.

The present disclosure, in an embodiment thereof, is a method designed to be used with mobile devices, such as smartphones or tablets [101]. In this embodiment, the involved mobile device has the following characteristics:
a mobile device capable of periodically or continuously acquiring the user's position without needing the user's input;
in a different embodiment, the mobile device is able to acquire the position each time that a significant movement is identified. The definition of “significant” depends by the technology used to obtain the coordinate, and it is not part of some embodiments of the present disclosure. The geographic location can be acquired through GPS signal reception technologies or using Assisted GPS (A-GPS) technologies [102], or any equivalent technology capable of providing the geographical location;
a mobile device capable of making network connections [104] to telecommunications networks [105] such as the Internet;
a mobile device [101] capable of running a software used to associate the payment instrument with the device itself;
a mobile device [101] capable of notifying the user with messages, avoiding the need for the user of a periodic manual check of the status of the payment instrument configuration.

The activation of the method described in the present description has as a prerequisite a step [201], to be carried out once, in which the payment instrument is associated with a device. The payment instrument, in an embodiment, is in turn associated with a single user. In this way, the association between a device and a user is also obtained. Thanks to this association, the terms “device position” and “user position” will be used herein below in an equivalent manner without the risk of incurring ambiguity.

Once the payment instrument is associated with the mobile device, the user's movements are monitored by starting the acquisition step of the user's geographical position.

The modern detection technologies of the user's position allow to choose between two acquisition modes:
Low consumption [202]: in which the user's position is detected less frequently and turning on the detection systems for a shorter time. This guarantees a minimum energy impact, at the cost of a possible minor accuracy of the geographic coordinate. The reason that makes useful this mode is that in order to reduce fraud the user must be encouraged to leave the feature on the device active indefinitely, confident that this feature will have a marginal impact on the energy consumption of the device.
High precision [205]: in which the user's position is detected with greater frequency and turning on the detection systems for a longer time. This implies a greater energy impact, but guarantees the maximum precision of the geographical coordinate, based on the used localization technology. The reason that makes this mode useful is that in order to reduce frauds the user must be guaranteed that the method will work even in critical conditions, such as when the user is near the border of the authorized area. In these cases, a rough geographical coordinate may not be sufficient to obtain an optimal effectiveness of the method described here.

Each time a position is acquired [203] the accuracy related to the acquisition is evaluated. If the accuracy is not considered sufficient in order to univocally identify an area, the system switches between “low consumption” [202] and “high precision” [205] modes.

Once the user's geographical coordinates have been obtained, they must be coded [206] through a procedure called reverse-geocoding to obtain some logical information, such as the address, the country and the nation relative to the coordinates itself.

In an embodiment, the encoding of the geographical coordinates takes place using remote services, in another embodiment the coding can take place on the device, using previously stored information and further limiting dependence on remote services.

The coordinates and/or logical information obtained in step [206] are compared with the set of positions included in the area currently authorized to make payments [207] and stored on the device. In a different embodiment, the comparison does not take place on the device, but the geographical coordinates are sent to a remote system that deals with the comparison.

If the system detects that the current position is not included in the area currently authorized to make payments then it starts the automatic configuration procedure of the payment instrument.

The system checks whether the necessary conditions exist for automatically configuring the payment instrument. In an embodiment, the control includes checking the ability to send commands to the remote payment instrument management system [208].

If the conditions are not verified, in an embodiment, the system acts, by warning the user of the event and waiting for these conditions to change. The notification sent to the user [209] is designed to prevent the payment instrument from being used in a condition in which it can not operate, causing inconvenience to the user.

In another embodiment the method proposes to the user an alternative communication channel, as for example the SMS channel. In this case the method produces a command that can be stransmitted through the alternative communication channel.

The procedure is also designed to react automatically to a change in the conditions necessary to complete the process and act as soon as possible. In an embodiment the system waits to be notified by the operating system of the mobile device about a change in the conditions [210] and, as soon as it receives this notification, it performs the automatic configuration procedure again [208].

If the conditions [208] are verified, the system sends the configuration change command of the payment instrument to the remote system [211]. The configuration change command, in an embodiment, includes an identifier that specifies the new area to be activated, the identifier of the payment instrument subject to the request, and other quantities necessary to ensure the IT security of the command such as, but not limited to:
a timestamp to identify the time when the request occurred
a unique identifier of the device
a unique identifier of the user
a cryptographic signature that authenticates all the data included in the command

In order to guarantee the security said command integrate all aformentioned security best practice, independently from the communication channel used.

The configuration change command is sent to the payment instrument management service [107], which in turn will communicate the change to the payment instrument provider [108] so that, at the time a transaction takes place, it can apply to the correct blocking policy based on the geographical position.

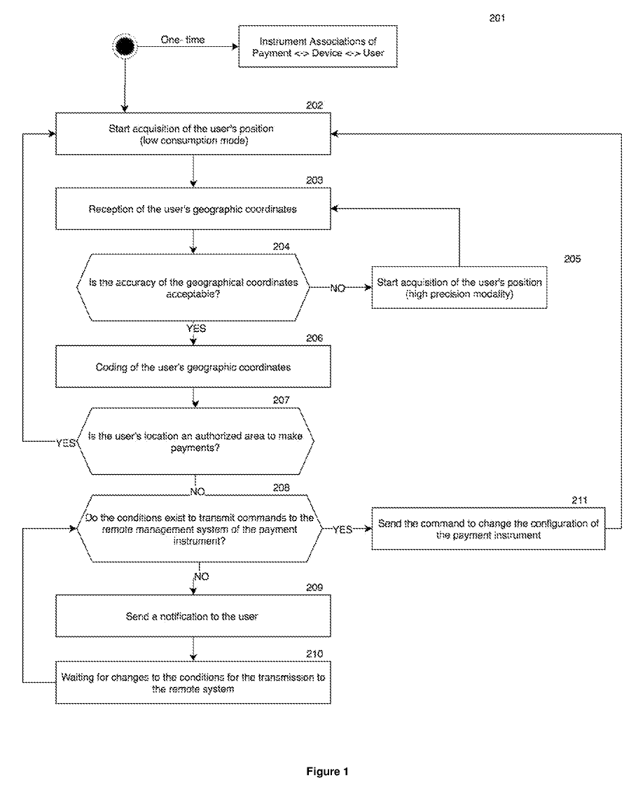

The present description should not be understood as the only one possible for the present disclosure. For example, the blocks [107] and [108] specified in FIG. 1 can be merged into a single block that has the responsibilities of both components. Another example is the communications network block [105] which may consist of the Internet, an intranet network, a point-to-point network, or any other communication network capable of carrying information.

Some aspects of embodiments of the present disclosure may be implemented by software or as hardware based processes, including embodiments on a single integrated circuit (such as an ASIC or an FPGA). Some aspects of embodiments of the present disclosure may be implemented in the form of a program code embodied in physical means, such as magnetic recording media, optical recording media, solid state memory, floppy disc, CD-ROMs, or any other computer-readable memory medium, wherein, when the program code is loaded and executed by a computer, such as a personal computer, a mobile device, or others, the computer becomes an apparatus to realize some embodiments of the disclosure. This is valid even if the aforesaid program is transferred and loaded using any transmission support, such as electric or coaxial cables, optical fibers, or electromagnetic radiation.

It will be understood that changes in the details, materials and arrangements of the parts that have been described and illustrated to explain the nature of some embodiments of the present disclosure can be made by the persons skilled in the field without departing from the scope of the disclosure as expressed in the following claims.

It will be understood that the steps of the illustrative methods presented here are not necessarily required to be performed in the order described, and the order of the steps of such methods should be understood as purely illustrative. In the same way, further steps can be included in such methods, and some steps may be omitted or combined, in consistent methods in various embodiments of the present disclosure.

1. A method for automatically enabling or disabling an authorized area in an electronic payment instrument configuration by processing the geographical position of a user associated with the instrument, wherein said method includes:
associating, in a preliminary and one time step, a device capable of detecting geographical coordinates with a payment instrument and with a user representing the legitimate user of the instrument;
and, subsequently, periodically, the following steps:
acquiring the geographical coordinates of the position of the aforementioned user, by means of said device, associated to the user, the geographical coordinates being acquired alternatively in continuous, or according to regular or irregular periodic time intervals;
checking if the acquired position is included in an area previously authorized to make payments;
in response to determining that the acquired position is not included within said area previously authorized to make payments;
automatically sending to a remote payment instruments management system a command to change the payment instrument configuration;
the command to change the payment instrument configuration, run by said remote system, enabling the area associated with the acquired position and simultaneously disabling the previously authorized area.

2. The method of claim 1, wherein said acquired geographic coordinates relates to the places visited by the user, including the places where the user stays for at least a preset minimum time, ignoring the coordinates related to the movements that lead the user to such places.

3. The method of claim 1, wherein said method includes the step of using information provided by the device used to acquire geographic coordinates even when this is in the conditions of having to provide the coordinates with an accuracy near its lower limit, in this case the system automatically acting by enabling an area with a boundary greater than or equal to said lower limit value.

4. The method of claim 1, wherein said method includes the step of automatically switching from a low-precision profile of the acquired geographic coordinates to a high-precision profile to maximize its effectiveness.

5. The method of claim 1, wherein said method includes the step of obtaining the user's logical position (reverse-geocoding) through the use of remote services and/or also by using information preloaded on the device and always available.

6. The method of claim 1, wherein said command to change the payment instrument configuration is communicated to a remote system that deals with the payment instrument management.

7. The method of claim 1, wherein, in the case of temporary lacking of the following requirements: a high precision geographical coordinates and/or of a working communication channel, a procedure of automatic recovery is activated, said procedure of automatic recovery including:
observing the requirements status change notifications, sent by the device itself, and
immediately reacting to those related to the aforesaid temporary lacking, in order to complete the procedure as soon as the requirements are restored, without a manual verification and, by delivering a proactive notification to the user, wherein said proactive notification informs the user of said temporary lacking.

8. The method of claim 7, wherein said proactive notification informs the user of possible alternative communication channel.

9. The method of claim 1, wherein the user's geographical position is obtained using a technology capable of acquiring geographical coordinates, such as GPS receivers or A-GPS position detection technologies or a combination thereof.

10. The method of claim 1, wherein the command to change the payment instrument configuration and all the necessary information for the execution of this command are communicated in an encrypted form and are decrypted when received by the payment instrument management system.

11. A non-transitory computer readable medium comprising instructions that, when executed by a processor, cause the processor to execute the method of claim 1.

12. A processor configured to execute the instructions of claim 11.
